(19) United States
(12) Patent Application Publication
(10) Pub. No.: US 2018/0282057 A1
(43) Pub. Date: Oct. 4, 2018

(54) CLEANING BLADE PACKAGING MATERIAL

(71) Applicant: SYNZTEC CO., LTD., Tokyo (JP)

(72) Inventors: Shuang WANG, Kanagawa (JP); Atsuo HASHIME, Kanagawa (JP); Shuji ABE, Kanagawa (JP); Hiroyuki SATO, Kanagawa (JP)

(21) Appl. No.: 15/765,394

(22) PCT Filed: Oct. 3, 2016
(86) PCT No.: PCT/JP2016/079285

§ 371 Date: Apr. 2, 2018

(30) Foreign Application Priority Data
Oct. 2, 2015 (JP) 2015-197161

(51) Int. Cl. B65D 85/20; G03G 21/00; B65D 85/68

(52) U.S. Cl. CPC B65D 85/20; B65D 2585/6892; B65D 85/68; G03G 21/0011

(57) ABSTRACT

Provided is a packaging material for cleaning blades including: a set of support part main bodies each supporting both end parts of holder parts; a connecting part for connecting the set of support part main bodies; and a storage part that is a space between the set of support part main bodies and that stores a plurality of the cleaning blades which are supported by the set of support part main bodies and are stacked in a vertical direction, wherein a first support part main body and a second support part main body in the set of support part main bodies support either of the end parts of the holder parts of the stacked plurality of cleaning blades, and are provided with a first supporting part or a second supporting part including a groove that extends in a vertical direction and is open at the upper side thereof.

### TECHNICAL FIELD

The present invention relates to a packaging material for cleaning blades to be incorporated in image forming apparatus, such as electrophotographic copiers and printers and toner-jet copiers and printers.

### BACKGROUND ART

Generally, in an electrophotographic process, at least a cleaning process, an electric charging process, an exposure process, a development process, and a transfer process are performed on an electrophotosensitive medium. These processes use a cleaning blade for removing remaining toner from the surface of a latent image carrier such as a photosensitive drum to clean the surface, an electrically conductive roller for imparting a uniform electrical charge to the photosensitive medium, a transfer belt for transfer of a toner image, etc. The cleaning blade is usually composed of a rectangular blade body which is brought into slide contact with the surface of the photosensitive drum, and a support member (also called a holder member) for supporting the blade body at a non-slide-contact portion.

Meanwhile, in packaging cleaning blades of such a type, there have been used a thin resin tray composed of a recessed storage part for storing blade bodies of the cleaning blades, and a convexed fixing part for fixing the support members of the cleaning blades, a tubular storage case formed according to the cleaning blades, and like packaging materials (see, for example, Patent Document 1). These packaging materials can protect the cleaning blades from vibration, shock, etc.

However, since the resin tray is formed from thin resin, a tray having enhanced load bearing performance is demanded. Also, since the resin tray stores the cleaning blades such that they are arrayed horizontally, a single resin tray can store a few cleaning blades only due to the restriction of space. Further, due to low storage rate for cleaning blades, packaging work requires a large number of resin trays; therefore, improvement of work efficiency and cost performance has been desired. Also, since the above-mentioned resin tray is apt to be deformed or broken, reuse of the resin tray is difficult, and disposal of resin tray wastes may increase environmental load and may deteriorate cost performance. Further, since the above-mentioned resin tray is fabricated in accordance with the shape of the cleaning blade in question, the resin tray encounters difficulty in application to cleaning blades having other shapes; thus, a highly versatile packaging material has been desired.

Similar to the case of the above-mentioned resin tray, the above-mentioned storage case also involves concern about storage performance, storage workability, cost performance, reusability, and versatility.

### PRIOR ART DOCUMENT

### Patent Document

Patent Document 1: Japanese Utility Model Application Laid-Open (kokai) No. S63-011669

### SUMMARY OF THE INVENTION

### Problem to be Solved by the Invention

The present invention is proposed in view of the above problem involved in the conventional technique, and an object of the invention is to provide a packaging material allowing reuse and exhibiting excellent cost performance and versatility, and an improved storage rate.

### Means for Solving the Problem

A packaging material for cleaning blades according to an embodiment of the present invention for solving the above problem is a packaging material for cleaning blades each having a blade body which is brought into slide contact with a surface of a latent image carrier, and a holder part for supporting a non-slide-contact portion of the blade body, comprising a set of support part main bodies supporting respective opposite end portions of the holder parts of the cleaning blades; a connecting part for connecting the set of support part main bodies; and a storage part in the form of a space between the set of support part main bodies for storing a plurality of the cleaning blades supported by the set of support part main bodies and stacked in a vertical direction. The packaging material for cleaning blades is characterized in that a first support part main body which is one of the set of support part main bodies has a first supporting part in the form of a groove extending in the vertical direction and opening upward, for supporting one end portions of the holder parts of the plurality of stacked cleaning blades and that a second support part main body which is the other of the set of support part main bodies has a second supporting part in the form of a groove extending in the vertical direction and opening upward, for supporting the other end portions of the holder parts of the plurality of stacked cleaning blades.

The packaging material for cleaning blades according to the above embodiment may be configured such that the first support part main body of the set of support part main bodies has a first insertion-removal opening for inserting or removing therethrough the one end portion of the holder part of the cleaning blade, and a first engagement-fixation portion for fixing the one end portions of the holder parts of the plurality of stacked cleaning blades through engagement with the first insertion-removal opening and such that the second support part main body of the set of support part main bodies has a second insertion-removal opening for inserting or removing therethrough the other end portion of the holder part of the cleaning blade, and a second engagement-fixation portion for fixing the other end portions of the holder parts of the plurality of stacked cleaning blades through engagement with the second insertion-removal opening.

The packaging material for cleaning blades according to the above embodiment may be configured such that the first supporting part has a surface for bearing the one end portion of the holder part of the cleaning blade and such that the second supporting part has a surface for bearing the other end portion of the holder part of the cleaning blade.

The packaging material for cleaning blades according to the above embodiment may be configured such that in the first supporting part, at least a portion of the surface for bearing the one end portion of the holder part of the cleaning blade is a first inclined surface inclined from a horizontal surface and such that in the second supporting part, at least a portion of the surface for bearing the other end portion of the holder part of the cleaning blade is a second inclined surface inclined from a horizontal surface.

The packaging material for cleaning blades according to the above embodiment may be configured such that the set of support part main bodies has a structure capable of restricting a longitudinal movement of the plurality of stacked cleaning blades stored in the storage part.

The packaging material for cleaning blades according to the above embodiment may be configured such that the first support part main body has a first positioning portion for determining at least one end position of the cleaning blade at the one end portions of the holder parts of the plurality of stacked cleaning blades and such that the second support part main body has a second positioning portion for determining at least one end position of the cleaning blade at the other end portions of the holder parts of the plurality of stacked cleaning blades.

The packaging material for cleaning blades according to the above embodiment may be configured such that the first positioning portion and the second positioning portion are contact surfaces in contact with respective end portions of the holder part of the cleaning blade, or inserting protrusions to be inserted through respective holes extending in a thickness direction through respective end portions of the holder part of the cleaning blade.

The packaging material for cleaning blades according to the above embodiment may be configured such that the first engagement-fixation portion has a first cushioning on at least a portion of a facing surface facing the one end portions of the holder parts of the plurality of stacked cleaning blades and such that the second engagement-fixation portion has a second cushioning on at least a portion of a facing surface facing the other end portions of the holder parts of the plurality of stacked cleaning blades.

The packaging material for cleaning blades according to the above embodiment may further comprise a lid member for closing the first supporting part and the second supporting part.

The packaging material for cleaning blades according to the above embodiment may further comprise a lid member for closing the first supporting part and the second supporting part and may be configured such that the lid member has the first engagement-fixation portion to be engaged with the first insertion-removal opening, and the second engagement-fixation portion to be engaged with the second insertion-removal opening at its longitudinally opposite end portions, respectively.

### Effects of the Invention

The present invention can implement a packaging material allowing reuse and exhibiting excellent cost performance and versatility, and an improved storage rate.

### BRIEF DESCRIPTION OF THE DRAWINGS

FIG. 1 Perspective view showing an example of a packaging material for cleaning blades according to embodiment 1.

FIG. 2 Front view of FIG. 1.

FIG. 3 Side view of FIG. 1.

FIG. 4 (a) is a side view of one support part main body of the packaging material for cleaning blades according to embodiment 1, and (b) is a side view of the other support part main body of the packaging material for cleaning blades according to embodiment 1.

FIG. 5 Perspective view showing an example of a mode of use of the packaging material for cleaning blades according to embodiment 1.

FIG. 6 Front view of FIG. 5.

FIG. 7 (a) is a side view of FIG. 5, and (b) is a sectional view taken along line A-A of FIG. 6.

FIG. 8 (a) is a perspective view showing an example of a cleaning blade applicable to the present invention, and (b) is a vertical sectional view of (a).

FIG. 9 Side view showing an example of a packaging material for cleaning blades according to embodiment 2.

FIG. 10 (a) is an enlarged fragmentary view of the plan view of the packaging material of FIG. 9 with a lid member removed, and (b) is a plan view of the packaging material of FIG. 9 with the lid member removed.

FIG. 11 (a) is a side view showing an example of a packaging material for cleaning blades according to embodiment 3, and (b) is a plan view of the packaging material of (a) with a lid member removed.

### MODES FOR CARRYING OUT THE INVENTION

The present invention will next be described in detail with reference to embodiments. The following description shows one mode of the present invention, and the present invention can be modified arbitrarily without departing from the gist of the invention. Since constituent elements denoted by the same symbols in the drawings are the same, repeated description thereof is omitted as appropriate. Letters (a and b) appearing in symbols are suffixed for convenience of description of a plurality of the same constituent elements, and symbols bearing the same numeral denote the same constituent elements unless otherwise specified.

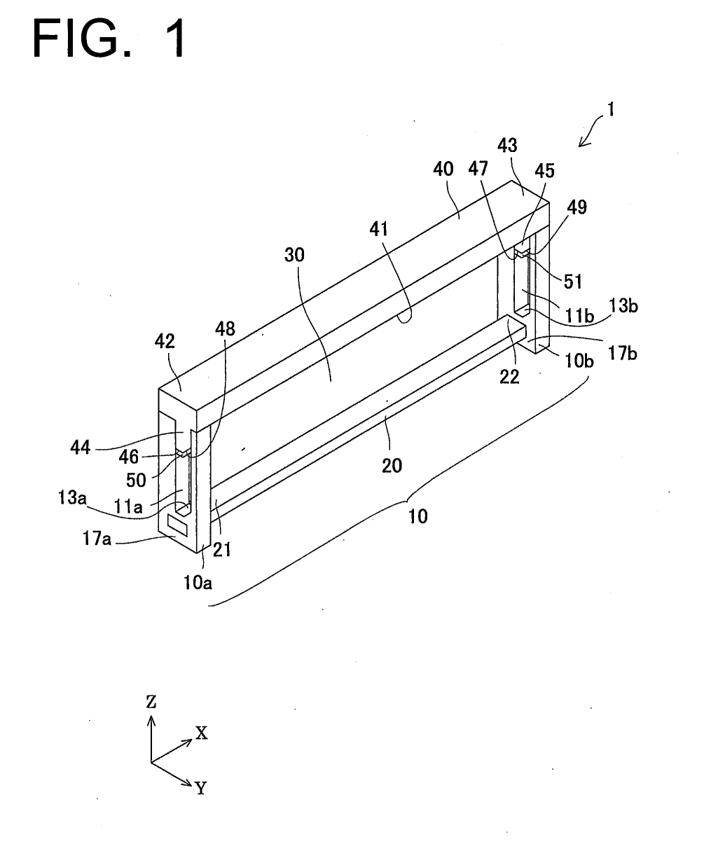

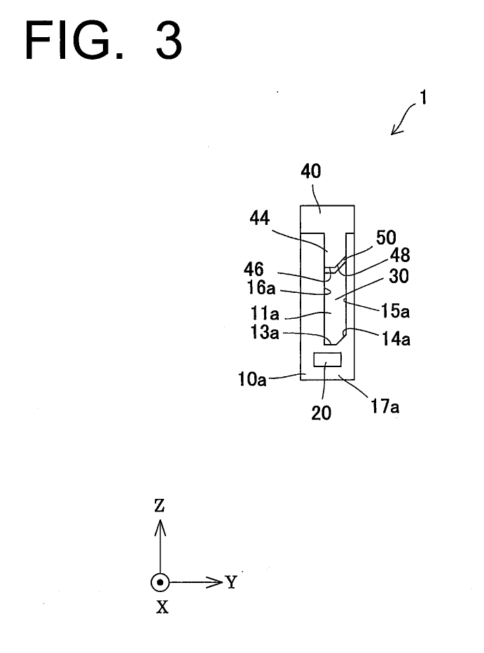

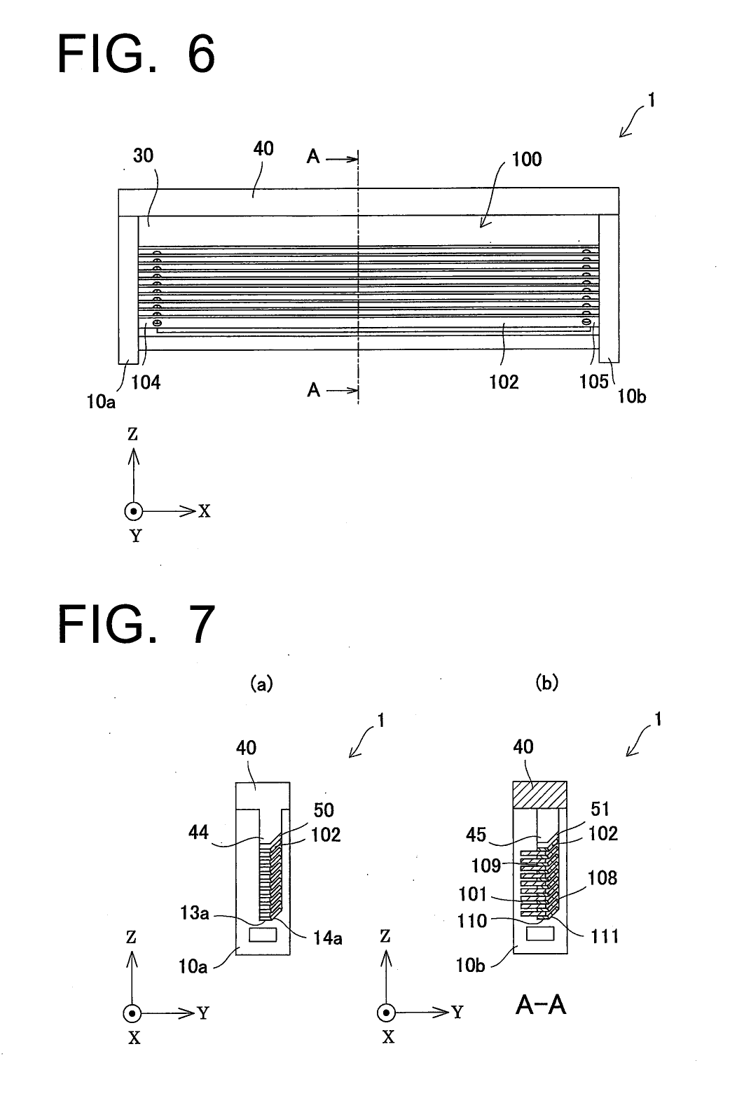

In FIGS. 1 to 7 and FIGS. 9 to 11, X, Y, and Z indicate three mutually orthogonal spatial axes. In the present specification, directions along the X-, Y-, and Z-axes are referred to as a first direction X (X-direction), a second direction Y (Y-direction), and a third direction Z (Z-direction), respectively. The X-direction and the Y-direction indicate in-plane directions of constituent elements, and the Z-direction indicates a height direction, a thickness direction, or a stacking direction of the constituent elements.

### Embodiment 1

### [1. Packaging Material for Cleaning Blades]

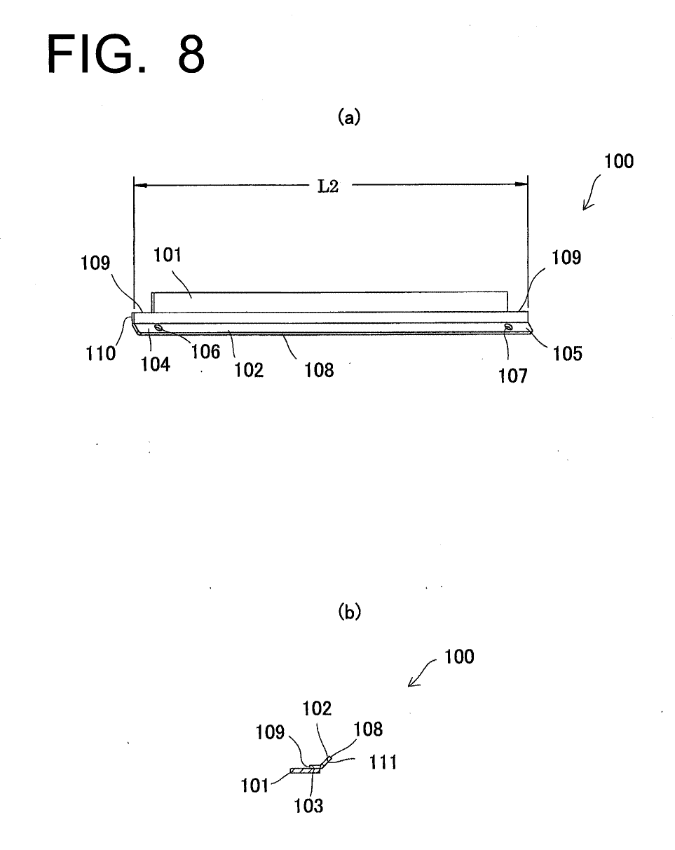

First, a packaging material for cleaning blades (hereinafter, called the “packaging material”) according to a first embodiment (hereinafter, called “embodiment 1”) of the present invention will be described. Although details will be described later herein, in embodiment 1, a cleaning blade 100 shown in FIGS. 8(a) and 8(b) is applied.

As shown in FIGS. 1 to 3 and FIGS. 4(a) and 4(b), a packaging material 1 is a thin frame formed of hard resin and has a set of support part main bodies 10 for supporting longitudinally opposite ends of the cleaning blade 100, a connecting part for connecting the set of support part main bodies 10, a storage part 30 in the form of a space between the set of support part main bodies 10, and a lid member 40 for closing the openings of the set of support part main bodies 10.

The set of support part main bodies 10 consists of a first support part main body 10a formed of a hard resin plate, and a second support part main body 10b formed of the hard resin plate. The first support part main body 10a and the second support part main body 10b have a first supporting part 11a and a second supporting part 11b, respectively, in the form of grooves extending therethrough in a thickness direction (X-direction) of the plate and extending in the vertical direction (Z-direction). The first supporting part 11a and the second supporting part 11b have a first insertion-removal opening 12a and a second insertion-removal opening 12b, respectively, opening upward. In the first support part main body 10a and the second support part main body 10b, longitudinally opposite end portions 104 and 105 of a holder part 102 of the cleaning blade 100 are inserted or removed from the first insertion-removal opening 12a and the second insertion-removal opening 12b, respectively.

The first supporting part 11a and the second supporting part 11b have, at their bottoms, a first bearing portion 13a in the form of a horizontal surface and a second bearing portion 13b in the form of a horizontal surface, respectively, and inclined surfaces 14a and 14b, respectively, inclined from the horizontal surfaces according to the shape of the holder part 102 of the cleaning blade 100. In the first supporting part 11a, one side wall portion 16a extends upward from one edge portion of the first bearing portion 13a, and the other side wall portion 15a extends upward from one edge portion of the inclined surface 14a, while in the second supporting part 11b, one side wall portion 16b extends upward from one edge portion of the second bearing portion 13b, and the other side wall portion 15b extends upward from one edge portion of the inclined surface 14b.

In the first supporting part 11a and the second supporting part 11b, when the opposite end portions 104 and 105 of the holder part 102 of the cleaning blade 100 are inserted from the first insertion-removal opening 12a and the second insertion-removal opening 12b, respectively, the first bearing portion 13a bears and supports one contact surface 110 of the end portion 104, and the inclined surface 14a bears and supports the other contact surface 111 of the end portion 104, while the second bearing portion 13b bears and supports one contact surface 110 of the end portion 105, and the inclined surface 14b bears and supports the other contact surface 111 of the end portion 105. As a result, a movement of the cleaning blade 100 in a downward direction (Z-direction) is restricted. Also, when the opposite end portions 104 and 105 are inserted from the first insertion-removal opening 12a and the second insertion-removal opening 12b, respectively, the one side wall portions 15a and 15b bear and support an upper edge portion 108 of the holder part 102, and the other side wall portions 16a and 16b bear and support a lower edge portion 109 of the holder part 102, thereby restricting a movement of the cleaning blade 100 in a lateral direction (Y-direction).

That is, the first supporting part 11a and the second supporting part 11b support the opposite end portions 104 and 105, respectively, of the holder part 102 of the cleaning blade 100 from four directions by means of the first bearing portion 13a and the second bearing portion 13b, the inclined surfaces 14a and 14b, and the opposite side wall portions 15a, 15b, 16a, and 16b, thereby restricting movements in the downward direction (Z-direction) and the lateral direction (Y-direction) and thus positioning the opposite end portions 104 and 105 of the holder part 102. As a result, the cleaning blade 100 is held in the storage part 30 to be described later herein, in a predetermined posture.

In the first supporting part 11a and the second supporting part 11b, when a plurality of the cleaning blades 100 are stacked on the cleaning blade 100 held in a predetermined posture, the plurality of cleaning blades 100 are stacked while following the posture of the bottom cleaning blade 100. Specifically, when another cleaning blade 100 is placed on the bottom cleaning blade 100 held in a predetermined posture as mentioned above, a non-slide-contact portion of a blade body 101 of the upper cleaning blade 100 comes into contact with a portion of the surface of the holder part 102 of the bottom cleaning blade 100. The non-slide-contact portion of the blade body 101 means a portion of the blade body 101 which does not come into slide contact with the surface of a latent image carrier (not shown) such as a photosensitive drum when the cleaning blade 100 is used in an image forming apparatus (an electrophotographic copier and printer, a toner-jet copier and printer, or the like).

Similar to the bottom cleaning blade 100, the cleaning blades 100 are sequentially stored in the storage part 30 in a stacked manner while the opposite end portions 104 and 105 of the holder parts 102 of the upper cleaning blades 100 are positioned. At this time, the stacked cleaning blades 100 are stored in the storage part 30 such that slide contact portions, which come into contact with the surface of a latent image carrier, of the blade body 101 of the lower cleaning blade 100 (including the bottom cleaning blade 100) and the blade body 101 of the adjacent upper cleaning blade 100 are not in contact with each other.

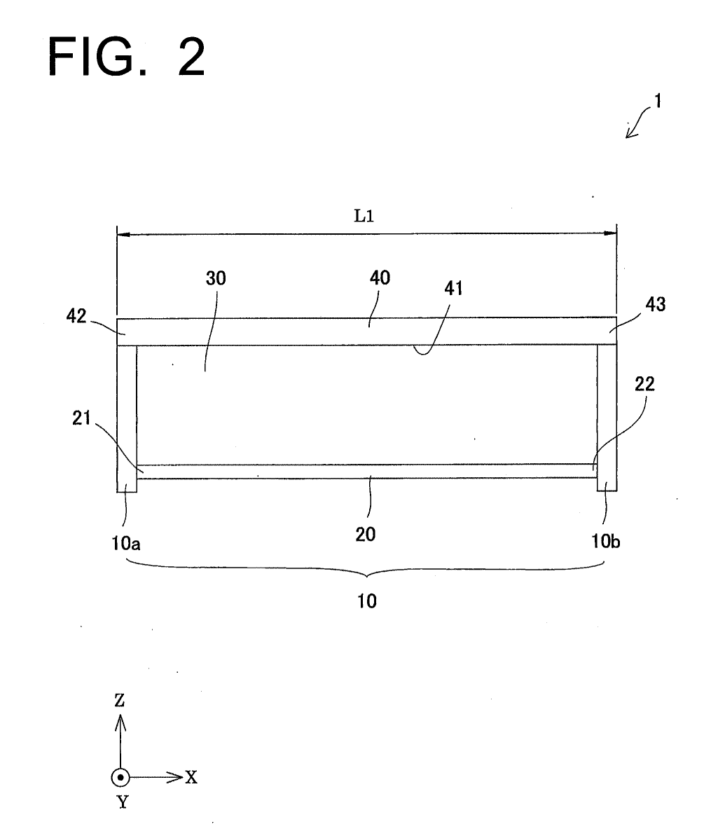

The first supporting part 11a and the second supporting part 11b have holes 18a and 18b formed respectively in one end portions 17a and 17b along a height direction (Z-direction) in such a manner as to extend therethrough in a thickness direction (X-direction) thereof. Opposite end portions 21 and 22 of the connecting part 20 are fixedly engaged with the holes 18a and 18b, respectively. That is, the connecting part 20 connects a set of the support part main bodies 10 consisting of the first support part main body 10a and the second support part main body 10b. As will be described in detail later herein, the connecting part 20 is formed of a hard resin plate and has a length L1 (see FIG. 2) longer than a length L2 (see FIG. 8(a)) of the cleaning blade 100 (L1>L2) to be packaged.

In the packaging material 1, as mentioned above, the length L1 of the connecting part 20 is greater than the length L2 of the cleaning blade 100, thereby forming the storage part 30 in the form of a space formed between the first supporting part 11a and the second supporting part 11b and adapted to store the stacked cleaning blades 100 held in a predetermined posture.

The lid member 40 is formed of a hard resin plate and has a first engagement-fixation portion 44 and a second engagement-fixation portion 45 which are formed at opposite end portions 42 and 43, respectively, of its lower surface 41 and can be fitted into and removed from the first insertion-removal opening 12a and the second insertion-removal opening 12b of the first supporting part 11a and the second supporting part 11b, respectively. Also, the surfaces of the first engagement-fixation portion 44 and the second engagement-fixation portion 45 which face the first supporting part 11a and the second supporting part 11b, respectively, have respective horizontal facing surfaces 46 and 47 corresponding to the first bearing portion 13a and the second bearing portion 13b in the form of horizontal surfaces, and respective inclined facing surfaces 48 and 49 which are inclined from the horizontal surfaces according to the shape of the holder part 102 of the cleaning blade 100. Further, cushionings 50 and 51 formed of sponge material are bonded to the entire horizontal facing surfaces 46 and 47 and to the entire inclined facing surfaces 48 and 49, respectively.

As described above, since the packaging material 1 is a thin frame formed of hard resin, the packaging material 1 has excellent load bearing performance and thus can prevent its deformation, breakage, etc., associated with handling thereof. Thus, the packaging material 1 can be collected and reused, thereby realizing a great reduction in the costs of packaging work, transportation, etc., of the cleaning blades 100. Also, since the packaging material 1 can be reused, the amount of disposal of packaging material 1 wastes can be reduced, whereby an increase in environmental load resulting from disposal of packaging material 1 wastes can be minimized, and the cost of disposal can be greatly reduced. Further, since the packaging material 1 is a thin frame, the amount of hard resin used to manufacture the packaging material 1 can be reduced, whereby the cost of manufacturing the packaging material 1 can be greatly reduced.

The main constituent elements of the packaging material 1 are a set of the support part main bodies 10 which supports longitudinally opposite ends of the cleaning blade 100, and the connecting part 20 which connects the set of support part main bodies 10. Basically, the cleaning blade 100 can be supported by these constituent elements. Thus, a cleaning blade which the packaging material 1 can support is determined by the shapes of the bottoms of the first supporting part 11a and the second supporting part 11b of the first support part main body 10a and the second support part main body 10b of the set of support part main bodies 10, and by the length of the connecting part 20.

That is, the packaging material 1 of embodiment 1 can also be applied to packaging of a cleaning blade so long as the shapes of the opposite ends of the cleaning blade coincide with the shapes of the bottoms of the first supporting part 11a and the second supporting part 11b or are similar to the shapes of the bottoms of the first supporting part 11a and the second supporting part 11b to such an extent that the cleaning blade can be supported by the packaging material 1. Also, since the length of the connecting part 20 can be changed as appropriate according to the length of a cleaning blade to be packaged, the packaging material 1 can also be applied to cleaning blades in various forms, indicating that the packaging material 1 has such high versatility and is thus useful. Since the packaging material 1 is highly versatile, the costs of packaging work, transportation, etc., of cleaning blades can be greatly reduced.

Since the packaging material 1 is configured such that the first support part main body 10a and the second support part main body 10b have the first supporting part 11a and the second supporting part 11b in the form of grooves, respectively, a plurality of the cleaning blades 100 can be stacked in the vertical direction (Z-direction). Also, in stacking the cleaning blades 100, since the stacked cleaning blades 100 are stored in the storage part 30 such that slide contact portions, which come into contact with the surface of a latent image carrier, of the blade body 101 of the lower cleaning blade 100 (including the bottom cleaning blade 100) and the blade body 101 of the adjacent upper cleaning blade 100 are not in contact with each other, the slide contact portions of the blade bodies 101 are not damaged.

The packaging material 1 can package the stacked cleaning blades 100 such that the cleaning blades 100 are stored in the storage part 30 in the condition that movements of the cleaning blades in the lower direction (Z-direction) and the lateral direction (Y-direction) are restricted. As a result, the packaging material 1 can greatly improve the storage rate for the cleaning blades 100 and can prevent the occurrence of deformation, breakage, etc., of the cleaning blades 100 by mitigating vibration, shock, etc., in the course of packaging work, transportation, etc.

The packaging material 1 can restrict the movement of the cleaning blades 100 in the upper direction (Z-direction) as follows: after the cleaning blades 100 are stored in the storage part 30, the first insertion-removal opening 12a and the second insertion-removal opening 12b are closed by the first engagement-fixation portion 44 and the second engagement-fixation portion 45, respectively, of the lid member 40. As a result, the packaging material 1 can prevent the occurrence of deformation, breakage, etc., of the cleaning blades 100 by preventing popping-out of the cleaning blades 100 and unnecessary interference between the cleaning blades 100 in the vertical direction particularly in the course of packaging work, transportation, etc.

Further, in the packaging material 1, since the cushionings 50 and 51 are bonded to the entire horizontal facing surfaces 46 and 47 and to the entire inclined facing surfaces 48 and 49, respectively, of the lid member 40, even when the first engagement-fixation portion 44 and the second engagement-fixation portion 45 of the lid member 40 press the respective opposite ends of the cleaning blade 100, the cushionings 50 and 51 play the role of cushions, thereby preventing deformation, breakage, etc., of the cleaning blade 100.

### [2. Mode of Use of Packaging Material for Cleaning Blades]

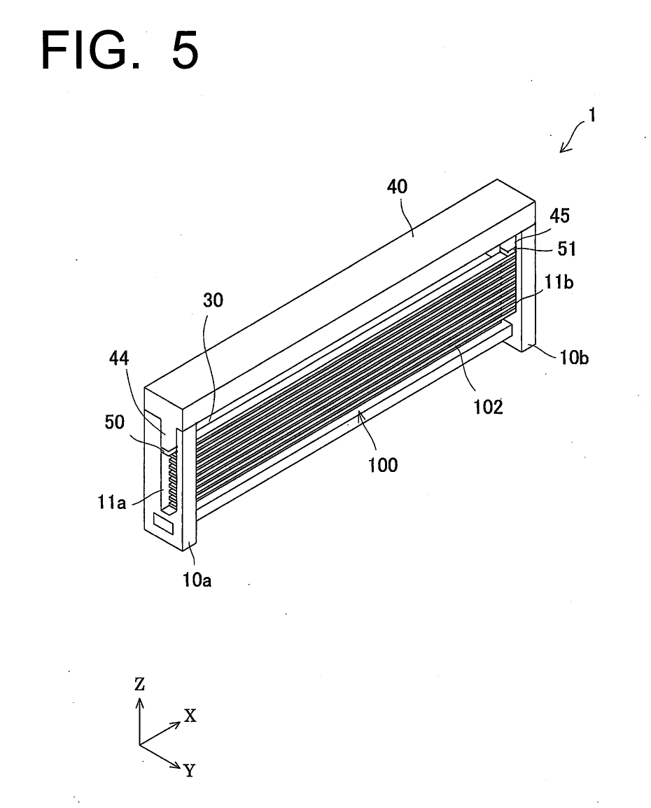

Next, a mode of use of the packaging material 1 will be described. As shown in FIG. 5 to FIGS. 7(a) and 7(b), first, the packaging material 1 and 10 cleaning blades 100 are prepared. The end portion 104 of the holder part 102 of the first cleaning blade 100 is inserted into the first supporting part 11a of the first support part main body 10a. At this time, the contact surface 110 of the end portion 104 comes into contact with the first bearing portion 13a of the first support part main body 10a; the contact surface 111 comes into contact with the inclined surface 14a; and the upper edge portion 108 and the lower edge portion 109 come into contact with the opposite side wall portions 15a and 16a, respectively. As a result, the end portion 104 is positioned by the first supporting part 11a.

Similarly, the end portion 105 of the holder part 102 is positioned by the second supporting part 11b of the second support part main body 10b. In this condition, the first cleaning blade 100 is stored in the storage part 30. Next, the second through tenth cleaning blades 100 are sequentially stacked on the first cleaning blade 100, whereby the second through tenth cleaning blades 100 are stored in the storage part 30.

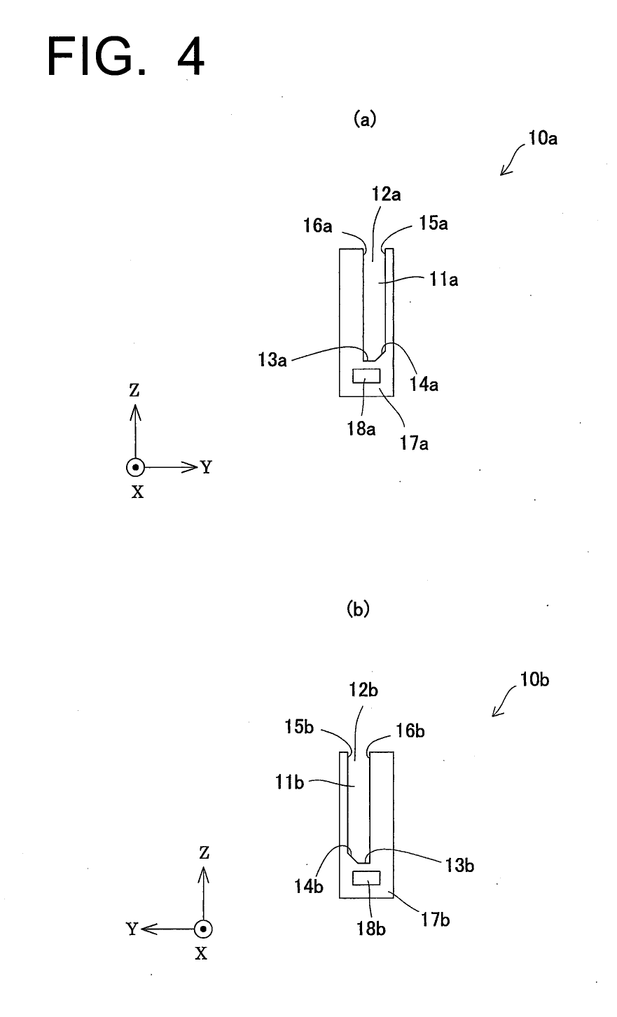

Next, the first engagement-fixation portion 44 and the second engagement-fixation portion 45 of the lid member 40 are engaged with the first insertion-removal opening 12a and the second insertion-removal opening 12b (see FIGS. 4(a) and 4(b)), respectively, thereby closing the openings 12a and 12b. At this time, the cushionings 50 and 51 bonded to the first engagement-fixation portion 44 and the second engagement-fixation portion 45, respectively, fixedly press the opposite end portions 104 and 105 of the holder part 102, thereby fixing the posture of the cleaning blade 100. By this procedure, packaging of the stacked cleaning blades 100 in the packaging material 1 is completed.

### [3. Cleaning Blade]

Next, cleaning blades applicable to the packaging material 1 will be described. The cleaning blades can be applied to embodiments 2 and 3 to be described later herein. The present invention can be applied to cleaning blades other than the cleaning blades, and modifications of cleaning blades are acceptable without departing from the gist of the invention.

As shown in FIGS. 8(a) and 8(b), the cleaning blade 100 includes the blade body 101 (also called a “cleaning blade”) which comes into slide contact with the surface of a latent image carrier (not shown) such as a photosensitive drum, and the holder part 102 which supports a non-slide-contact portion of the blade body 101. More specifically, the cleaning blade 100 includes the blade body 101 and the holder part 102 bonded to a laterally one end portion 103 of the blade body 101 through an adhesive (not shown).

The blade body 101 is formed of a rectangular plate, and the material of the plate is not particularly limited, but can be appropriately selected as needed so long as the blade body 101 can clean off remaining toner from the surface of the latent image carrier without damaging the surface of the latent image carrier. For example, the blade body 101 can be an elastic member formed of a rubber-based material. The shape of the blade body 101 is not limited to a rectangular shape, but can be modified as appropriate according to an image forming apparatus (an electrophotographic copier and printer, a toner-jet copier and printer, or the like) to which the cleaning blade 100 is applied.

A material of the holder part 102 can be appropriately selected as needed so long as the material has an appropriate strength for supporting the blade body 101. For example, the holder part 102 may be formed of metal such as SUS. The shape of the holder part 102 is not limited to the illustrated shape, but can be modified as appropriate according to an image forming apparatus to which the cleaning blade 100 is applied, so long as the holder part 102 can support the blade body 101.

The holder part 102 has holes 106 and 107 having an approximately circular shape in plan view and extending through the longitudinally opposite end portions 104 and 105 thereof in the thickness direction thereof. No particular limitation is imposed on the diameter, shape, etc., of the holes 106 and 107; the holes 106 and 107 may be identical or differ in diameter, shape, etc.; and the diameter, shape, etc., can be appropriately changed as needed.

### Embodiment 2

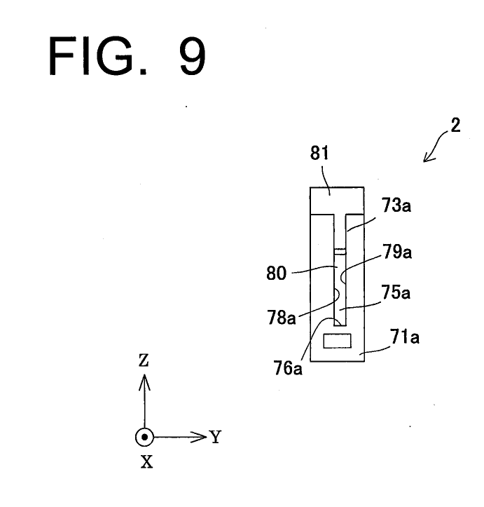

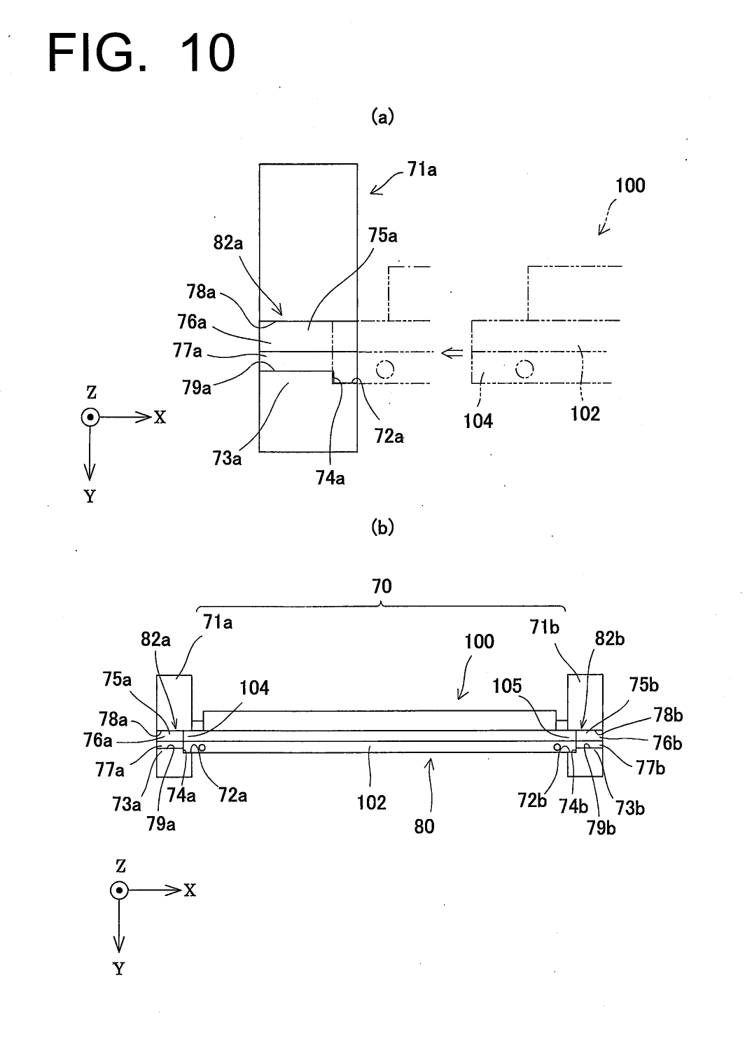

A packaging material according to a second embodiment (hereinafter, called “embodiment 2”) of the present invention will next be described. As shown in FIG. 9 and FIGS. 10(a) and 10(b), a packaging material 2 is a modification of the packaging material 1 of embodiment 1 and is similar in structure to the packaging material 1 except for use of a set of support part main bodies 70 having a structure capable of restricting the movement in a longitudinal direction (X-direction) of the stored cleaning blades 100. Therefore, the description of embodiment 2 discusses only points of difference of the packaging material 2 from the packaging material 1, and repeated description of similar features is omitted.

The set of support part main bodies 70 consists of a first support part main body 71a and a second support part main body 71b. The second support part main body 71b is of a mirror image of the first support part main body 71a. The first support part main body 71a has a first positioning portion 73a formed by protruding a portion of its side wall portion 72a. Similarly, the second support part main body 71b has a second positioning portion 73b formed by protruding a portion of its side wall portion 72b.

The first positioning portion 73a is a stopper integral with the side wall portion 72a and has a contact surface 74a with which the one end portion 104 along a longitudinal direction of the holder part 102 of the cleaning blade 100 stored in the storage part 80 comes into contact. The first positioning portion 73a restricts the movement in the longitudinal direction (X-direction) of the cleaning blade 100 by means of the contact surface 74a, thereby filling the role of a stopper. Similarly, the second positioning portion 73b has a contact surface 74b with which the other end portion 105 of the holder part 102 comes into contact, whereby the second positioning portion 73b restricts the movement in the longitudinal direction (X-direction) of the cleaning blade 100, thereby filling the role of a stopper.

In the packaging material 2, similar to the packaging material 1, when the end portion 104 of the holder part 102 is placed in a first supporting part 75a of the first support part main body 71a, the end portion 104 is restricted in movements in the downward direction (Z-direction), the lateral direction (Y-direction), and the longitudinal direction (X-direction) of the cleaning blade 100 by a first bearing portion 76a, an inclined surface 77a, opposite side wall portions 78a and 79a, and the contact surface 74a of the first supporting part 75a, thereby being positioned.

Similarly, in the packaging material 2, when the end portion 105 of the holder part 102 is placed in a second supporting part 75b of the second support part main body 71b, the end portion 105 is positioned by a second bearing portion 76b, an inclined surface 77b, opposite side wall portions 78b and 79b, and the contact surface 74b of the second supporting part 75b, whereby the cleaning blade 100 is held in a predetermined posture in the storage part 80. Then, other cleaning blades 100 are sequentially stacked in the positioned posture on the cleaning blade 100, whereby the stacked cleaning blades are held in the storage part 80.

Subsequently, similar to the packaging material 1, a lid member 81 closes a first insertion-removal opening 82a and a second insertion-removal opening 82b of the first supporting part 75a and the second supporting part 75b, respectively. As a result, the opposite end portions 104 and 105 of the holder parts 102 are fixedly pressed, thereby restricting the movement in the upward direction (Z-direction) of the stacked cleaning blades 100. Packaging of the stacked cleaning blades 100 in the packaging material 2 is thus completed.

According to embodiment 2, as mentioned above, portions of the side wall portions 72a and 72b of the first support part main body 71a and the second support part main body 71b, respectively, are protruded to thereby form the first positioning portion 73a and the second positioning portion 73b, whereby the packaging material 2 can store the stacked cleaning blades 100 while restricting the movement in the longitudinal direction of the cleaning blades 100 in addition to the movements in the vertical and lateral directions of the cleaning blades 100. As a result, as compared with the packaging material 1, the packaging material 2 can prevent the occurrence of deformation, breakage, etc., of the cleaning blades 100 by mitigating vibration, shock, etc., in the course of packaging work, transportation, etc.

### Embodiment 3

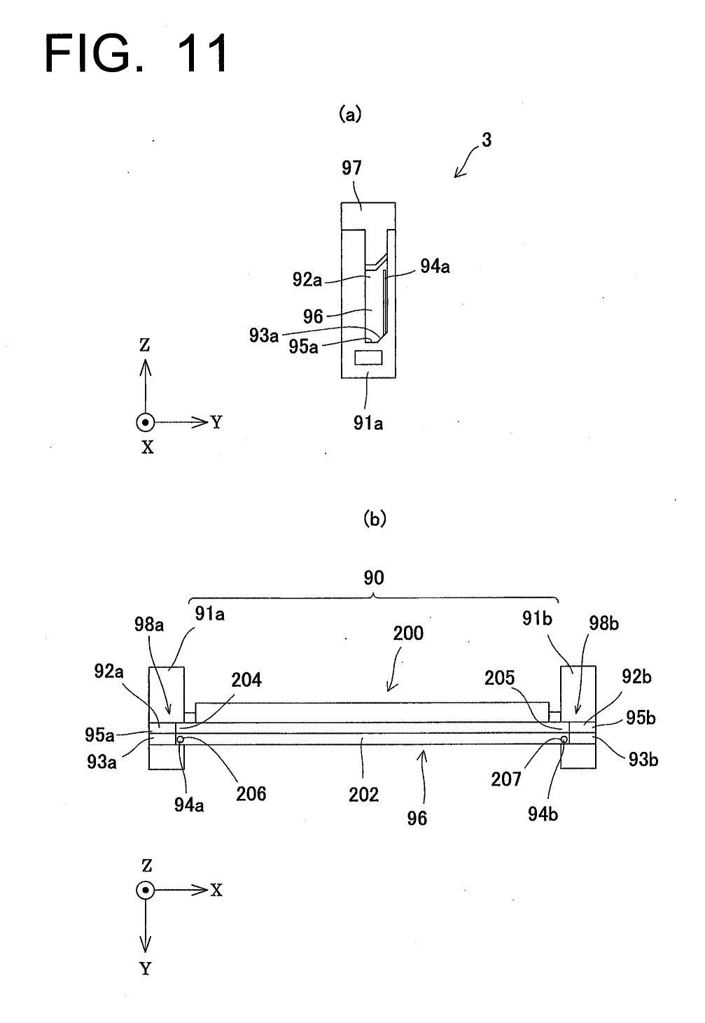

A packaging material according to a third embodiment (hereinafter, called “embodiment 3”) of the present invention will next be described. Embodiment 3 is adapted for a cleaning blade 200 having a structure similar to that of the cleaning blade 100 applied to embodiment 1 except for the positions of holes 206 and 207 as shown in FIG. 11(b). As shown in FIGS. 11(a) and 11(b), a packaging material 3 is a modification of the packaging material 1 of embodiment 1 and is similar in structure to the packaging material 1 except for use of a set of support part main bodies 90 having a structure capable of restricting the longitudinal movement of the stored cleaning blades 200. Therefore, the description of embodiment 3 discusses only points of difference of the packaging material 3 from the packaging material 1, and repeated description of similar features is omitted.

The set of support part main bodies 90 consists of a first support part main body 91a and a second support part main body 91b. The second support part main body 91b is of a mirror image of the first support part main body 91a. The first support part main body 91a has a first inserting protrusion 94a protruding from an inclined surface 93a of a first supporting part 92a for insertion through the hole 206 formed in one end portion 204 along a longitudinal direction of a holder part 202 of the cleaning blade 200. Similarly, the second support part main body 91b has a second inserting protrusion 94b protruding from an inclined surface 93b of a second supporting part 92b for insertion through the hole 207 formed in the other end portion 205 of the holder part 202.

The first inserting protrusion 94a and the second inserting protrusion 94b are rodlike stoppers and are inserted respectively through the holes 206 and 207 formed in the opposite end portions 204 and 205 of the holder part 202, thereby fixing respectively the opposite end portions 204 and 205 on a first bearing portion 95a and a second bearing portion 95b, and on the inclined surfaces 93a and 93b to thereby restrict the movement in the longitudinal direction (X-direction) of the cleaning blade 200, and thus filling the role of stoppers.

In the packaging material 3, similar to the packaging material 1, when the end portion 204 of the holder part 202 is placed in the first supporting part 92a of the first support part main body 91a, the end portion 204 is restricted in movements in the downward direction (Z-direction), the lateral direction (Y-direction), and the longitudinal direction (X-direction) of the cleaning blade 100 by the first bearing portion 95a, the inclined surface 93a, and the first inserting protrusion 94a, thereby being positioned.

Similarly, in the packaging material 3, when the end portion 205 of the holder part 202 is placed in the second supporting part 92b of the second support part main body 91b, the end portion 205 is positioned by the second bearing portion 95b, the inclined surface 93b, and the second inserting protrusion 94b, whereby the cleaning blade 200 is held in a predetermined posture in a storage part 96. Then, other cleaning blades 200 are sequentially stacked in the positioned posture on the cleaning blade 200, whereby the stacked cleaning blades are held in the storage part 96.

Subsequently, similar to the packaging material 1, a lid member 97 closes a first insertion-removal opening 98a and a second insertion-removal opening 98b of the first supporting part 92a and the second supporting part 92b, respectively. As a result, the opposite end portions 204 and 205 of the holder parts 202 are fixedly pressed, thereby restricting the movement in the upward direction (Z-direction) of the stacked cleaning blades 200. Packaging of the stacked cleaning blades 200 in the packaging material 3 is thus completed.

According to embodiment 3, as mentioned above, the first inserting protrusion 94a and the second inserting protrusion 94b are formed on the inclined surfaces 93a and 93b of the first support part main body 91a and the second support part main body 91b, respectively, whereby the packaging material 3 can store the stacked cleaning blades 200 while restricting the movement in the longitudinal direction of the cleaning blades 200 in addition to the movements in the vertical and lateral directions of the cleaning blades 200. As a result, as compared with the packaging material 1, the packaging material 3 can prevent the occurrence of deformation, breakage, etc., of the cleaning blades 200 by mitigating vibration, shock, etc., in the course of packaging work, transportation, etc.

### (Modifications of Packaging Material for Cleaning Blades)

The packaging material of the present invention may be manufactured such that the constituent elements (a set of the support part main bodies, the lid, the connecting part, etc.) are formed separately and are then assembled together. In this case, the set of support part main bodies can consist of the same members (hereinafter, called the common members) for common use, whereby the cost of manufacture can be reduced through simplification of the manufacturing process. Also, the packaging material of the present invention may be manufactured such that an integrally formed member of the set of support part main bodies and the connecting part, and a separately formed lid member are assembled together.

The present invention does not limit materials for the constituent elements to a hard resin, and the materials can be appropriately selected as needed, so long as deformation, breakage, etc., of the packaging material in the course of packaging work, transportation, etc., can be prevented. Also, the present invention does not impose particular limitation on the shapes of the packaging material and the constituent elements (a set of the support part main bodies, the lid member, the connecting part, etc.), and the shapes can be appropriately modified as needed, so long as the shapes are suited for packaging the cleaning blades.

The present invention allows the shapes, sizes, etc., of constituent elements of the packaging material main bodies to be appropriately modified according to cleaning blades to which the present invention is applied. Notably, the constituent elements of the packaging material main bodies are the supporting parts, the insertion-removal openings, etc.

For example, the inclined surface of the supporting part may be changed to a horizontal surface or to an inclined surface having a different angle of inclination or a special surface having a protrusion or the like formed thereon according to the shape of a cleaning blade to be packaged. Also, the shapes of constituent surfaces of the supporting part are not particularly limited, but can be appropriately modified as needed, so long as the supporting part can support the holder part from at least three directions (in the case where the inclined surface is changed to a horizontal surface) so as to hold a cleaning blade in a predetermined posture through reception of the holder part of the cleaning blade.

The shape, size, etc., of the hole in the supporting part can be modified as appropriate according to the sectional shape of the connecting part.

The shape, size, etc., of the lid member can be modified as appropriate according to the size of the cleaning blade, so long as the lid member can reliably close the insertion-removal openings of the supporting parts and can restrict an upward movement of the cleaning blades. Also, the position of disposition, the range of disposition, the shape, etc., of the cushioning bonded to the facing surfaces of the lid member are not particularly limited, but can be appropriately modified as needed.

For example, the range of disposition of the cushioning of the lid member is not limited to the entire facing surface of each engagement-fixation portion of the lid member, but can be appropriately modified as needed, so long as the cushioning is bonded to at least a portion of the facing surface.

The material of the cushioning is not limited to sponge, but can be appropriately selected as needed, so long as the material prevents direct contact between the engagement-fixation portion of the lid member and the cleaning blade and functions as cushioning.

The present invention employs the positioning portion formed integrally with one support part main body of a set of the support part main bodies as a structure for restricting a movement in the longitudinal direction of the stored cleaning blades. However, the structure is not limited, but can be modified as appropriate according to the shape of opposite end portions of the cleaning blade, so long as a movement in the longitudinal direction of stored cleaning blades can be restricted.

For example, the positioning portion may be a member formed separately from the set of support part main bodies, or the other support part main body may have the positioning portion formed integrally therewith. The present invention is not required to provide the positioning portion according to the length along the longitudinal direction of the cleaning blade.

The connecting part can be modified as appropriate according to the length of a cleaning blade to be stored, so long as the packing material can hold its overall shape and can package cleaning blades while preventing dropping of the cleaning blades.

### INDUSTRIAL APPLICABILITY

The packaging material for cleaning blades according to the present invention is preferred for packaging the cleaning blades for use in image forming apparatus, such as electrophotographic copiers and printers and toner-jet copiers and printers, for transportation or the like of the cleaning blades.

### DESCRIPTION OF REFERENCE NUMERALS

1, 2, 3: packaging material
10, 70, 90: a set of support part main bodies
10a, 71a, 91a: first support part main body
10b, 71b, 91b: second support part main body
11a, 75a, 92a: first supporting part
11b, 75b, 92b: second supporting part
12a, 82a, 98a: first insertion-removal opening
12b, 82b, 98b: second insertion-removal opening
13a, 76a, 95a: first bearing portion
13b, 76b, 95b: second bearing portion
14a, 14b, 77a, 77b, 93a, 93b: inclined surface
15a, 15b, 16a, 16b, 72a, 72b, 78a, 78b, 79a, 79b: side wall portion
17a, 17b: end portion
18a, 18b: hole
20: connecting part
21, 22: end portion
30, 80, 96: storage part
40, 81, 97: lid member
41: lower surface
42, 43: end portion
44: first engagement-fixation portion
45: second engagement-fixation portion
46, 47: horizontal facing surface
48, 49: inclined facing surface
50, 51: cushioning
73a: first positioning portion
73b: second positioning portion
74a, 74b: contact surface
94a: first inserting protrusion
94b: second inserting protrusion
100, 200: cleaning blade
101: blade body
102, 202: holder part
103, 104, 105, 204, 205: end portion
106, 107, 206, 207: hole
108: upper edge portion
109: lower edge portion
110, 111: contact surface

1-10. (canceled)

11. A packaging material for cleaning blades each having a blade body which is brought into slide contact with a surface of a latent image carrier, and a holder part for supporting a non-slide-contact portion of the blade body, comprising:
a set of support part main bodies supporting respective opposite end portions of the holder parts of the cleaning blades;
a connecting part for connecting the set of support part main bodies; and
a storage part in the form of a space between the set of support part main bodies for storing a plurality of the cleaning blades supported by the set of support part main bodies and stacked in a vertical direction;
wherein a first support part main body which is one of the set of support part main bodies has a first supporting part in the form of a groove extending in the vertical direction and opening upward, for supporting one end portions of the holder parts of the plurality of stacked cleaning blades, and
a second support part main body which is the other of the set of support part main bodies has a second supporting part in the form of a groove extending in the vertical direction and opening upward, for supporting the other end portions of the holder parts of the plurality of stacked cleaning blades.

12. A packaging material for cleaning blades according to claim 11, wherein
the first support part main body of the set of support part main bodies has a first insertion-removal opening for inserting or removing therethrough the one end portion of the holder part of the cleaning blade, and a first engagement-fixation portion for fixing the one end portions of the holder parts of the plurality of stacked cleaning blades through engagement with the first insertion-removal opening, and
the second support part main body of the set of support part main bodies has a second insertion-removal opening for inserting or removing therethrough the other end portion of the holder part of the cleaning blade, and a second engagement-fixation portion for fixing the other end portions of the holder parts of the plurality of stacked cleaning blades through engagement with the second insertion-removal opening.

13. A packaging material for cleaning blades according to claim 11, wherein
the first supporting part has a surface for bearing the one end portion of the holder part of the cleaning blade, and
the second supporting part has a surface for bearing the other end portion of the holder part of the cleaning blade.

14. A packaging material for cleaning blades according to claim 13, wherein
in the first supporting part, at least a portion of the surface for bearing the one end portion of the holder part of the cleaning blade is a first inclined surface inclined from a horizontal surface, and
in the second supporting part, at least a portion of the surface for bearing the other end portion of the holder part of the cleaning blade is a second inclined surface inclined from a horizontal surface.

15. A packaging material for cleaning blades according to claim 11, wherein the set of support part main bodies has a structure capable of restricting a longitudinal movement of the plurality of stacked cleaning blades stored in the storage part.

16. A packaging material for cleaning blades according to claim 15, wherein
the first support part main body has a first positioning portion for determining at least one end position of the cleaning blade at the one end portions of the holder parts of the plurality of stacked cleaning blades, and
the second support part main body has a second positioning portion for determining at least one end position of the cleaning blade at the other end portions of the holder parts of the plurality of stacked cleaning blades.

17. A packaging material for cleaning blades according to claim 16, wherein the first positioning portion and the second positioning portion are contact surfaces in contact with respective end portions of the holder part of the cleaning blade, or inserting protrusions to be inserted through respective holes extending in a thickness direction through respective end portions of the holder part of the cleaning blade.

18. A packaging material for cleaning blades according to claim 12, wherein
the first engagement-fixation portion has a first cushioning on at least a portion of a facing surface facing the one end portions of the holder parts of the plurality of stacked cleaning blades, and
the second engagement-fixation portion has a second cushioning on at least a portion of a facing surface facing the other end portions of the holder parts of the plurality of stacked cleaning blades.

19. A packaging material for cleaning blades according to claim 11, further comprising a lid member for closing the first supporting part and the second supporting part.

20. A packaging material for cleaning blades according to claim 12, further comprising a lid member for closing the first supporting part and the second supporting part,
wherein the lid member has the first engagement-fixation portion to be engaged with the first insertion-removal opening, and the second engagement-fixation portion to be engaged with the second insertion-removal opening at its longitudinally opposite end portions, respectively.
